(19) United States
(12) Patent Application Publication
(10) Pub. No.: US 2024/0402802 A1
(43) Pub. Date: Dec. 5, 2024

(54) CONTENT BRIGHTNESS AND TINT ADJUSTMENT

(71) Applicant: APPLE INC., Cupertino, CA (US)

(72) Inventors: Travis W. BROWN, Boulder, CO (US); Seyedkoosha MIRHOSSEINI, Santa Clara, CA (US); John Samuel BUSHELL, Santa Clara, CA (US); Alexander G. BERARDINO, San Francisco, CA (US); David M. COOK, Broomfield, CO (US); Jim J. TILANDER, Manhattan Beach, CA (US); Ryan W. BAKER, Los Angeles, CA (US)

(21) Appl. No.: 18/732,953

(22) Filed: Jun. 4, 2024

Related U.S. Application Data
(60) Provisional application No. 63/470,902, filed on Jun. 4, 2023.

(51) Int. Cl. G06F 3/01; G09G 3/00

(52) U.S. Cl. CPC G06F 3/013; G09G 3/003; G09G 2320/0666; G09G 2320/0686; G09G 2354/00

(57) ABSTRACT

Various implementations disclosed herein include devices, systems, and methods that adjust a brightness characteristic of virtual content (e.g., virtual objects) and/or real content (e.g., passthrough video) in views of an XR environment provided by a head mounted device (HMD). The brightness characteristic may be adjusted based on determining a viewing state (e.g., a user's eye perception/adaptation state). A viewing state, such as a user's eye perception/adaptation state while viewing a view of an XR environment via an HMD, may respond to a brightness characteristic of the XR environment that the user is seeing, which is not necessarily the brightness characteristic of the physical environment upon which the view is wholly or partially based.

### CROSS-REFERENCE TO RELATED APPLICATIONS

This application claims the benefit of U.S. Provisional Application Ser. No. 63/470,902 filed Jun. 4, 2023, which is incorporated herein in its entirety.

### TECHNICAL FIELD

The present disclosure generally relates to systems, methods, and devices that adjust content displayed in views of extended reality (XR) environments.

### BACKGROUND

Existing XR environment presentation techniques may not adequately utilize brightness and tint adjustments to provide perceptually accurate and desirable user experiences. For example, such techniques may not adequately utilize brightness and tint in integrating content from different sources, e.g., depictions of physical environments with depictions of virtual content items to provide views with particular viewing, thematic, or other intended attributes.

### SUMMARY

Various implementations disclosed herein include devices, systems, and methods that adjust a brightness characteristic of virtual content (e.g., virtual objects) and/or real content (e.g., passthrough video) in views of an XR environment provided by a head mounted device (HMD). The XR environment may depict all real content (e.g., only passthrough), only virtual content (e.g., only VR), or a combination. The brightness characteristic may be adjusted based on determining a viewing state (e.g., a user's eye perception/adaptation state). A viewing state, such as a user's eye perception/adaptation state while viewing a view of an XR environment via an HMD, may respond to a brightness characteristic of the XR environment that the user is seeing, which is not necessarily the brightness characteristic of the physical environment upon which the view is wholly or partially based.

In some implementations, real (e.g., passthrough video) and/or virtual content (e.g., videos, user interfaces, or other virtual objects) is provided based on the current viewing state, e.g., in a way that is consistent with that viewing state or in a way intended to change the viewing state. In some implementations, the brightness of real and/or virtual content is adjusted such that, when presented in a subsequent view of the XR environment, it is in line with (e.g., using brightness range values in line with) the brightness of the XR environment that the user is actually seeing, e.g., within an HMD. In some implementations, the current brightness of the XR environments is used to predict or otherwise determine that a current viewing state is light adapted or dark adapted and the subsequent content (e.g., virtual content to be added) is adjusted to be consistent with viewing in a light-adapted or dark-adapted viewing state accordingly. In some implementations, the current brightness of the XR environments is used to predict or otherwise determine that a current viewing state is at a level along a light-adaptation scale (e.g. 0-10) and the subsequent content (e.g., virtual content to be added) is adjusted to be consistent with that level.

Some implementations adjust a user's view to shift the viewing state, e.g., shifting the user's eye perception/adaptation state. The user's perceptual/adaptation state may be shifted based on context (e.g., what content is being viewed or about to be viewed, the type of environment, the type of activity, etc.). The user's perceptual/adaptation state may be shifted based on a requirement of content to be displayed in a dark environment or to a user having a dark-adapted perceptual state. The user's perceptual/adaptation state may be shifted based on a requirement of content to be displayed in a bright environment or to a user having a bright-adapted perceptual state. Brightness adjustments to real and/or virtual content may be based on a context that is identified based on a type of activity or use. Brightness adjustment may be based on a priority associated with a type of activity or use, e.g., a camera/reality priority prioritizing consistency with the brightness of the physical environment for a first type of activity, a media/virtual content priority prioritizing optimal presentation of virtual content for reading, entertainment, etc. for a second type of activity, a collaboration/creation priority prioritizing consistency between multi-user views of common content for a third type of activity, etc.

In some implementations, an electronic device has a processor (e.g., one or more processors) that executes instructions stored in a non-transitory computer-readable medium to perform a method. The method performs one or more steps or processes. In some implementations, the method presents a first view (e.g., one or more frames) of an XR environment on a display while an HMD is worn by a user. The display may produce substantially all of the light that is visible to an eye of the user. The first view may be all virtual (e.g., of a 3D VR world), all real (e.g., passthrough video of a 3D physical world), or a combination/blend of virtual and real content depictions. The method determines a viewing state (e.g., an eye adaptation state of the eye) based at least in part on a first brightness characteristic of the first view. A viewing state may be determined and/or confirmed using an inward eye camera or other sensor to assess pupil dilation or other user characteristics. The method determines a second brightness characteristic (e.g., remapping content brightness to a new brightness range) for at least a portion (e.g., real/passthrough portion, virtual portion, or both) of a second view of the XR environment based on the viewing state. The method presents the second view of the XR environment accordingly.

Some implementations provide immersive environment themes (e.g., fall, spring, summer, winter) using color tinting, e.g., tinting some or all portions of real content such as passthrough video of a physical environment. The tinting may provide the content with an intended white point, e.g., a cool bluish color for winter or a warm color for fall. In some implementations, an electronic device has a processor (e.g., one or more processors) that executes instructions stored in a non-transitory computer-readable medium to perform a method. The method performs one or more steps or processes. In some implementations, the method determines a viewing theme for an XR environment to be viewed on a display while an HMD is worn by a user. For example, a target color scheme may be defined by content to be displayed or an app configured to display content. The method obtains image data depicting a physical environment and maps (e.g., adjusts the color values, brightness values, etc.) the image data based on a predetermined white point. This may involve dynamic color tone-mapping, for example, by a camera ISP to map a camera image to a predefined neutral white point. The method applies a color effect to the image data based on the viewing theme. For example, this may involve applying an additive color tint in a dedicated camera-to-display path to apply the color. The method presents a view of the XR environment based on the image data.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRA WINGS

So that the present disclosure can be understood by those of ordinary skill in the art, a more detailed description may be had by reference to aspects of some illustrative implementations, some of which are shown in the accompanying drawings.

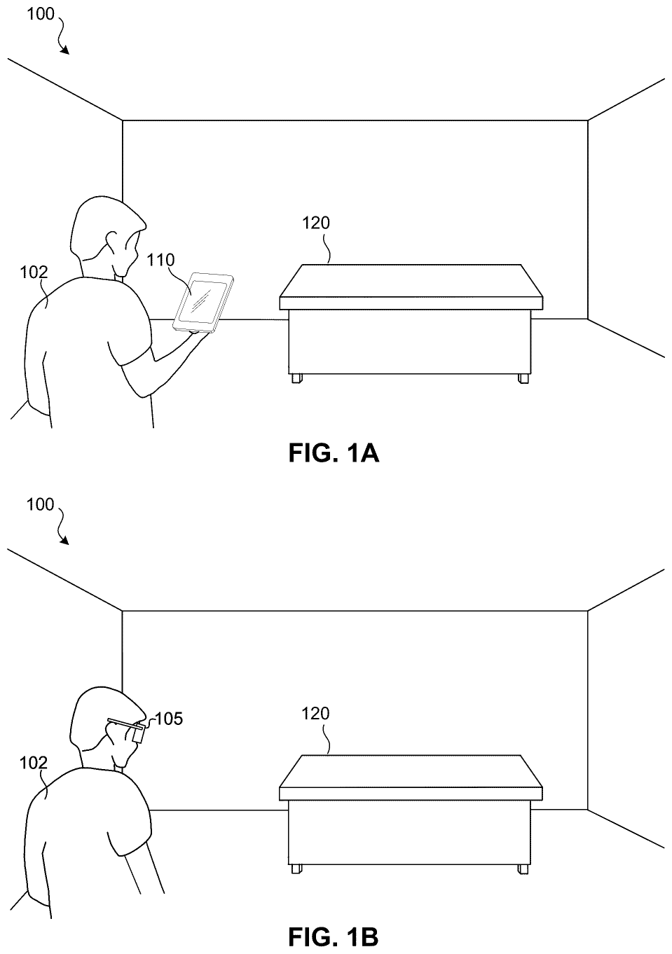

FIGS. 1A-B illustrate exemplary electronic devices operating in a physical environment in accordance with some implementations.

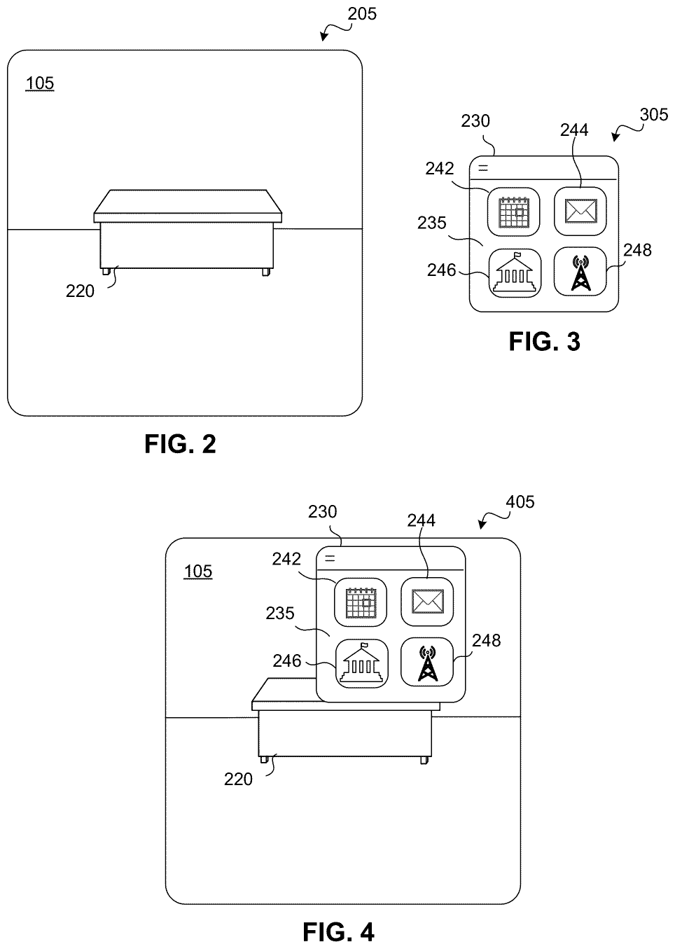

FIG. 2 illustrates an exemplary view of an XR environment in which the view provides passthrough video of a physical environment in accordance with some implementations.

FIG. 3 illustrates an example of virtual content to be added to the view of the XR environment of FIG. 2.

FIG. 4 illustrates a view of an XR environment including passthrough video of a physical environment and virtual content in accordance with some implementations.

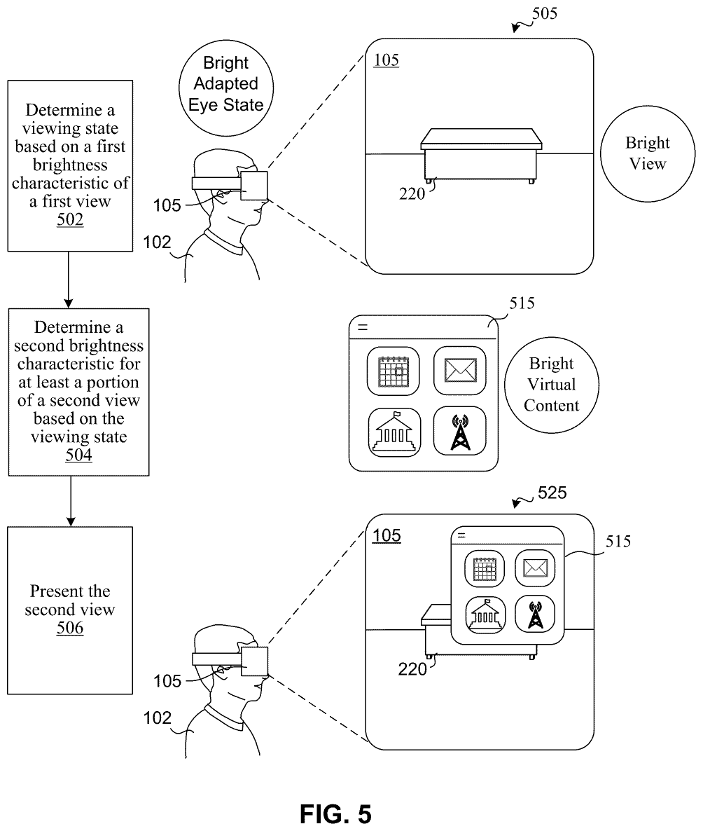

FIG. 5 illustrates presenting views of an XR environment based on determining a viewing state in accordance with some implementations.

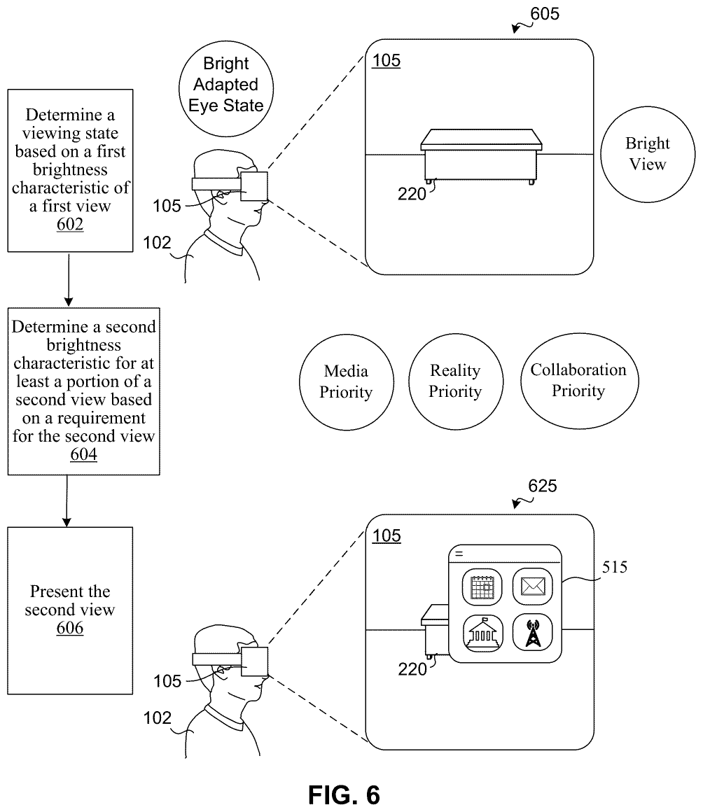

FIG. 6 illustrates presenting views of an XR environment based on determining a content requirement in accordance with some implementations.

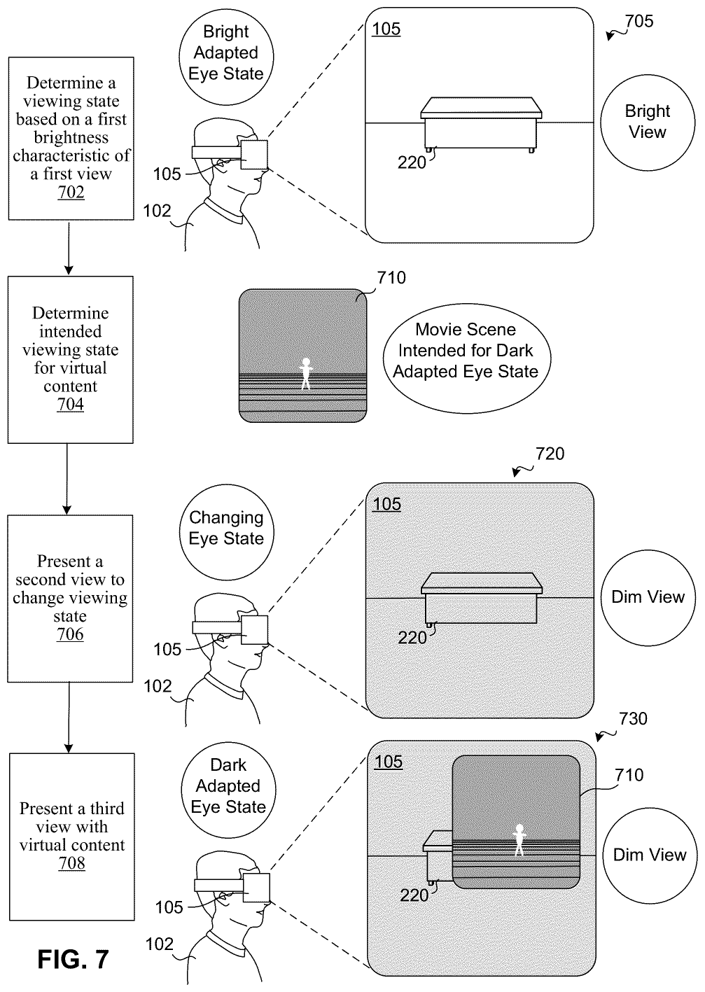

FIG. 7 illustrates presenting views of an XR environment to change a viewing state in accordance with some implementations.

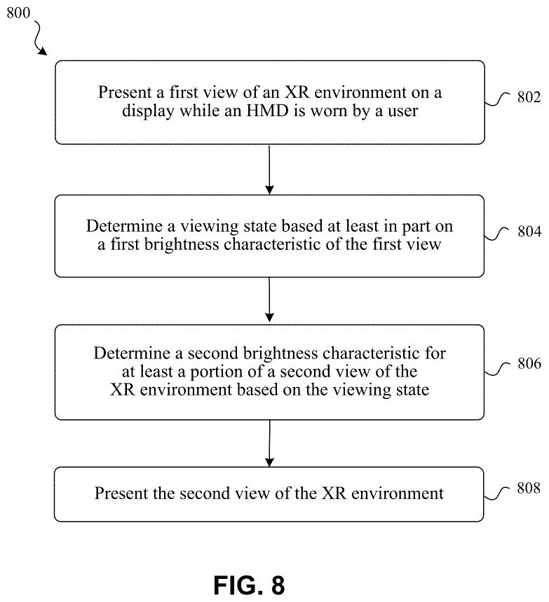

FIG. 8 is a flowchart illustrating an exemplary method for presenting views of an XR environment based on a viewing state, in accordance with some implementations.

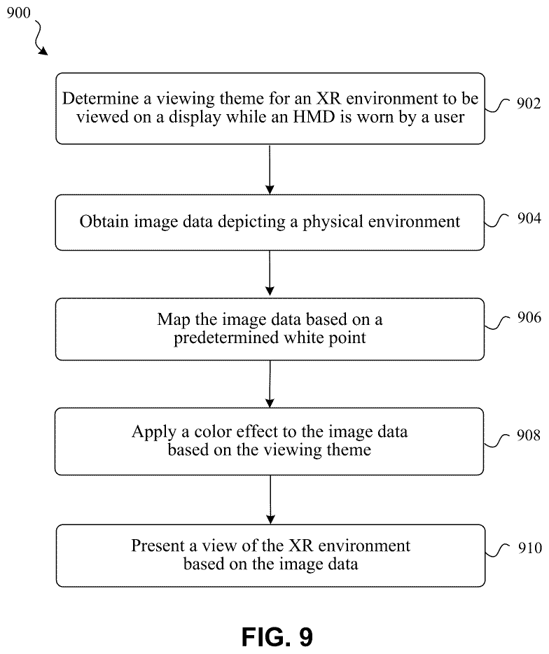

FIG. 9 is a flowchart illustrating an exemplary method for presenting views of an XR environment based on a viewing theme, in accordance with some implementations.

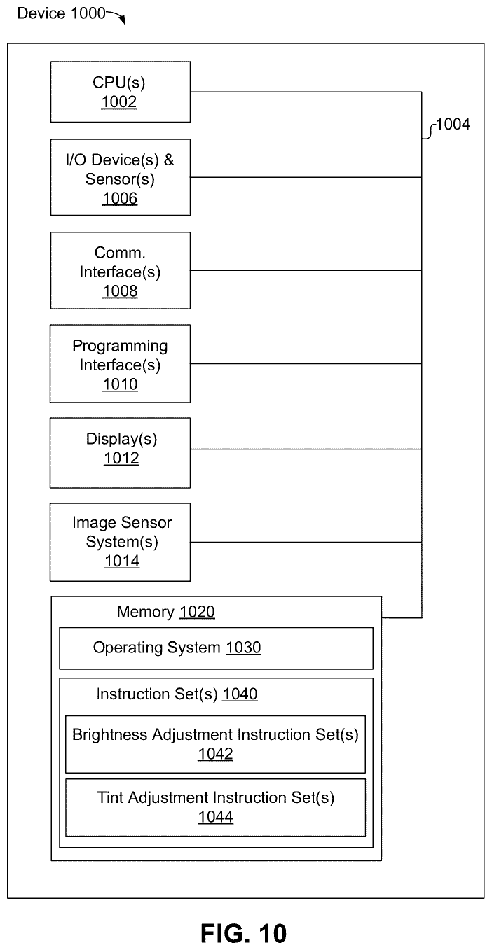

FIG. 10 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

FIGS. 1A-B illustrate an example environment 100 including exemplary electronic devices 105 and 110 operating in a physical environment 100. In the example of FIGS. 1A-B, the physical environment 100 is a room that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content (e.g., associated with the user 102) and/or to identify the current location of the physical environment 100 and/or the location of the user within the physical environment 100. In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include passthrough video views of a 3D environment (e.g., the proximate physical environment 100) that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

FIG. 2 illustrates an exemplary view 205 of an XR environment in which the view 205 provides passthrough video of a physical environment 100, including a depiction 220 of desk 120. In one example, device 105 (FIG. 1) may have one or more outward facing cameras or other image sensors that captures images (e.g., video) of the physical environment 100 that are sequentially displayed on a display of the device 105. The video may be displayed in real-time and thus can be considered passthrough video of the physical environment 100. The video may be modified, e.g., warped or otherwise adjusted, to correspond to a viewpoint of an eye of the physical environment, e.g., so that the user 102 sees the passthrough video of the physical environment from the same viewpoint that user would view the physical environment from if not wearing the device 105 (e.g., seeing physical environments directly with their eye). In some implementations, passthrough video is provided to each of the user's eyes, e.g., with a single outward facing camera capturing images that may be warped/altered to provide a video from the viewpoint of each eye or from multiple outward-facing cameras that provide image data (warped or un-warped) to each eye's viewpoint respectively.

The view 205 may be provided by a device such as device 105 having a display that provides substantially all of the light visible by an eye of the user. For example, the device 105 may be an HMD having a light seal that blocks ambient light of the physical environment 100 from entering an area between the device 105 and the user 102 while the device is being worn such that the device's display provides substantially all of the light visible by the eye of the user. A device's shape may correspond approximately to the shape of the user's face around the user's eyes and thus, when worn, may provide an eye area (e.g., including a eye box) that is substantially sealed from direct/ambient light from the physical environment.

In some implementations, a view of an XR environment includes only depictions of a physical environment such as physical environment 100. A view of an XR environment 100 may be entirely passthrough video. A view of an XR environment may be depict a physical environment based on image, depth, or other sensor data obtained by the device, e.g., generating a 3D representation of the physical environment based on such sensor data and then providing a view of that 3D representation from a particular viewpoint. In some implementations, the XR environment includes entirely virtual content, e.g., an entirely virtual reality (VR) environment that includes no passthrough or other depictions of the physical environment 100. In some implementations, the view of the XR environment includes depictions of both virtual content and depictions of a physical environment 100.

FIG. 3 illustrates an example of virtual content 305 to be added to the view 205 of the XR environment of FIG. 2. In this example, the virtual content 305 includes a user interface 230 (e.g., of an app) that includes a background area 235 and icons 242, 244, 246, 248. In this example, the virtual content 305 is approximately planar. In other implementations, virtual content 305 may include non-planar content such as 3D elements.

FIG. 4 illustrates a view 405 of an XR environment including passthrough video of the physical environment 100 and virtual content 305. In this example, the view 405 includes passthrough video including depiction 220 of the desk 120 of the physical environment, as well as virtual content including user interface 230. The virtual content (e.g., user interface 230) may be positioned within the 3D coordinate system as the passthrough video such that the virtual content appears at a consistent position (unless intentionally repositioned) within the XR environment. For example, the user interface 230 may appear at a fixed position relative to the depiction 220 of the desk 120 as the user changes their viewpoint and views the XR environment from different positions and viewing directions. Thus, in some implementations, virtual content is given a fixed position within the 3D environment (e.g., providing world-locked virtual content). In some implementations, virtual content is provided at a fixed position relative to the user (e.g., user-locked virtual content), e.g., so that the user interface 230 will appear to the user remain a fixed distance in front of the user, even as the user moves about and views the environment with virtual content added from different viewpoints.

Providing a view of an XR environment may utilize various techniques for combining the real and virtual content. In one example, 2D images of the physical environment are captured and 2D content of virtual content (e.g., depicting 2D or 3D virtual content) is added (e.g., replacing some of the 2D image content) at appropriate places in the images such that an appearance of a combined 3D environment (e.g., depicting the 3D physical environment with 2D or 3D virtual content at desired 3D positions within it) is provided in the view. The combination of content may be achieved via techniques that facilitate real-time passthrough display of the combined content. In one example, the display values of some of the real image content is adjusted to facilitate efficient combination, e.g., changing the alpha values of real image content pixels for which virtual content will replace the real image content so that a combined image can be quickly and efficiently produced and displayed.

FIG. 5 illustrates presenting views of an XR environment based on determining a viewing state. In this example, the user 102 wears device 105 while the device 105 displays a first view 505 of an XR environment including a depiction 220 of desk 120. The device 105 provides the first view 505 by displaying passthrough video on the display. In this example, the passthrough video includes (or is based upon) images of a physical environment 100 around the user 102. In one example, passthrough video for a left eye is captured from an outward facing camera and warped to provide an image for a left eye viewpoint of the user and passthrough video for a right eye is captured from an outward facing camera (e.g., the same or a different camera) and warped to provide an image for a right eye viewpoint of the user. For simplicity, FIG. 5 (and other figures herein) illustrates only a single eye viewpoint's view. However, each eye may be (and generally will be in the case of an HMD-type device) provided its own view.

In this example, the first view 505 is based on physical environment 100 and, in this example, is a relatively bright view, e.g., where the physical environment is illuminated with a significant amount of light from light sources (e.g., the sun or artificial light sources) within the physical environment 100. While the first view 505 is based on the physical environment 100, its brightness characteristics may differ from those of the physical environment 100. For example, the first view 505 may be provided on a display with output limitations such that only a certain amount of brightness and/or brightness range is possible. Accordingly, passthrough video displayed as the first view 505 may have an average brightness and/or brightness range that differs from those of the physical environment 100.

Presentation of the first view 505 may be associated with a viewing state particularly if the device 105 provides substantially all of the light that is received by the user's eye. For example, when first view 505 has a relatively high average brightness, the user's eye may adapt accordingly, e.g., exhibiting a bright-adapted eye state. Conversely, when first view 505 has a relatively dark average brightness, the user's eye may adapt accordingly, e.g., exhibiting a dark-adapted eye state. The viewing state may correspond to more nuanced eyes states, e.g., eye adaptation states that can be associated with a level on a numeric scale (e.g., 0-10). Eye adaptation state may be based on the user's physical/physiological response (e.g., based on pupil dilation) and/or cognitive response (e.g., based on a measure of perceptual awareness) to the amount of light the user is exposed to at a given time. In the case of a device, such as device 105, providing substantially all of the light to which an eye is exposed, the viewing state may correspond to what is displayed, e.g., the eye adaptation state may depend on the brightness characteristics of what is currently being displayed to the user 102.

In FIG. 5, at block 502, a method determines a viewing state based on a first brightness characteristic of a first view. In the illustrated example, based on determining that the first view 505 is a bright view (e.g., having an average brightness above a threshold), a bright adapted eye state is determined as the viewing state. In another example, a numerical or descriptive bright state may be determined based on the first view 505. For example, based on determining that the average brightness of the first view 505 is between two threshold values, the method may determine that an eye adaptation state value of 3 on a scale of 0 to 10 (e.g., with 0 being entirely/fully dark adapted and 10 being entirely/fully light adapted).

At block 504, the method determines a second brightness characteristic for at least a portion of a second view based on the viewing state. The second view, to be provided after the first view in this example, may include additional content. For example, while first view 505 may include only passthrough video content, the second view may include virtual content to be added to the passthrough video content. In this example, virtual content 515 is intended to be included in the second view with the passthrough video content. A second brightness characteristic for the virtual content 515 to be added (or the virtual content 515 and the passthrough content) is determined based on the viewing state. For example, based on determining that the viewing state is a bright-adapted eye state, a bright display characteristic may be selected for virtual content 515. In one example, the virtual content 515 is configured to have an average brightness that corresponds to the viewing state. In one example, the virtual content is configured to have an average brightness that corresponds to the average brightness of the first view 505.

At block 506, the second view 525 is presented accordingly. In the illustrated example, the second view 525 is presented such that the brightness of the added virtual content 515 is in line with the user's eye adaptation state, e.g., a bright adapted eye state. Accordingly, the added virtual content 515 may be in-line with, visually fit with, and/or otherwise be consistent with the user's continuing perceptual experience.

FIG. 6 illustrates presenting views of an XR environment based on determining a content requirement. In this example, the user 102 wears device 105 while the device 105 displays a first view 605 of an XR environment including a depiction 220 of desk 120. The device 105 provides the first view 605 by displaying passthrough video on the display, for example, based on images of a physical environment 100 around the user 102. In this example, the first view 605 is based on physical environment 100 and, in this example, is a relatively bright view. Presentation of the first view 605 is associated with a viewing state.

At block 602, a method determines a viewing state based on a first brightness characteristic of a first view. In the illustrated example, based on determining that the first view 605 is a bright view (e.g., having an average brightness above a threshold), a bright adapted eye state is determined as the viewing state.

At block 604, the method determines a second brightness characteristic for at least a portion of a second view based on a requirement for the second view. The second brightness characteristic may be based on the viewing state, determined to change the viewing state, and/or based on requirements that depend upon passthrough to be displayed, virtual content to be displayed, context (e.g., the intended use or activity), and/or the viewing state. In some implementations, the second brightness characteristic is independent of the viewing state.

The second view, to be provided after the first view in this example, may include additional content. For example, while first view 605 may include only passthrough video content, the second view may include virtual content to be added to the passthrough video content. In this example, virtual content is intended to be provided with a particular focus (e.g., for a particular use, for a particular type of activity, in a particular context, etc.)

One such exemplary focus is a focus on media (e.g., media first) to be presented as the virtual content. With such a focus, the user is expected to engage more with the virtual content than the passthrough content. For example, the virtual content may include a user interface that the user is expected to interact with to perform a task, e.g., organizing photos of a photo library in which the user will interact with virtual content displaying thumbnail images of the photos. In another example, the virtual content may include a movie that the user is expected to watch. In another example, the virtual content may include a virtual sculpture that the user is expected to be virtually sculpt using a sculpting app. With such a focus, a requirement to adapt brightness characteristics of the view to meet the focus on the virtual content may be provided. For example, during display of a user interface for a work session, the user interface may be displayed with enhanced brightness and/or the passthrough may be provided with diminished brightness to emphasize the user interface. As another example, during display of a movie, the movie may be displayed using cinema brightness characteristics and/or the passthrough may be provided with diminished brightness to provide a dark cinema-like (e.g., movie-theater-like) atmosphere.

Another such exemplary focus is on reality (e.g., reality first). With such a focus, the user is expected to engage more with the depictions of the physical environment (e.g., passthrough content) than with virtual content. There may be things to be shown in a view that are in conflict with one another, e.g., due to technical requirement of a piece of media, a brightness requirement, etc. Reality first may prioritize camera passthrough, e.g., for accuracy or other requirements. This may involve presenting the passthrough based on the passthrough display requirements and then conforming other content (e.g., virtual objects) accordingly. Virtual content may be highly influenced by the brightness and other characteristics of the camera passthrough. In one example, passthrough has a first optimal set of characteristics and virtual content may be associated with a second set of characteristics (e.g., dynamic ranges, etc.) and the reality first may involve adapting the second set of characteristics used for the virtual content to match or otherwise coordinate with the first set of characteristics. The first set of characteristics may guide the presentation/second set of characteristics to create a more integrated combination of the passthrough and virtual content. In one example of a reality first mode, the user may be walking in their kitchen and see virtual content augmentations labeling objects in the physical environment and/or providing augmentations meant to facilitate interactions with real objects. The view may be adapted so that the brightness or other characteristics of the virtual content (i.e., the augmentations) matches (as closely as possible given display limitations) the actual appearance/brightness characteristics of the physical environment 100 so that the virtual content appears to belong there.

Another such exemplary focus is on collaborative creation (e.g., creation first). With such a focus, the user is expected to engage with virtual content with another user. Such collaboration may occur at the same time or at different times as one or more other users. For example, two users (each using their own respective devices) may work together to design the appearance of a webpage using a collaborative webpage creation app. With such a focus, a requirement to adapt brightness characteristics of the view to provide a common or otherwise consistent level of brightness (and corresponding consistent virtual content appearance) may be provided. For example, the view may be adapted so that its brightness matches the brightness provided to other user(s) involved in a collaborative experience.

At block 606, the second view 625 is presented. In the illustrated example, the second view 625 is presented such that the brightness of the added virtual content 515 satisfies the brightness requirement of the virtual content. Accordingly, the added virtual content 515 may be shown using a brightness characteristic (e.g., an average brightness or a brightness range) that is intended to emphasis the virtual content over the passthrough video. In one example, the brightness range of the passthrough video is reduced below the limits of the display (e.g., the display may allow brightness 0-100 and the passthrough may use 0-50) and the virtual content is displayed without reduced brightness (e.g., using the full 0-100 brightness range). Such adjustment of brightness characteristics may be used to emphasis the virtual content, e.g., making its brightest whites brighter than and thus appearing to stand out more than anything in the passthrough content.

The views presented could be entirely virtual, e.g., presenting a VR environment. For example, first view 605 of the XR environment could be entirely virtual, e.g., not presenting depiction 220 of desk 120 or other portions of physical environment 100. The device 105 could provide such a first view 605 by maintaining a 3D representation of a virtual environment, e.g., a 3D model of a scene, and generating the first view 605 based on a determined viewpoint. That viewpoint could depend on movement of the user, e.g., changing as a user changes the position of the device. In one example, the user wears an HMD and 6DOF movements of HMD provide corresponding movements to the viewpoint. Such changes in viewpoint based on changes in device position may provide an immersive experience.

In such a view of an all-virtual environment, the system may render UI content (e.g., virtual content 515) on top of, in front of, or otherwise integrated with an entirely virtual environment with no passthrough, such as a 3D rendering of a national park. In such an example, the system may adjust the brightness of the UI content (e.g., virtual content 515) that is added/blended with that scenic environment content based on the brightness of the virtual environment in a manner similar to that described with respect to video passthrough of a real environment.

Some implementations provide views of virtual environments brightness characteristics that are adjusted in a naturalistic way, e.g., similar to how content is blended and adjusted for use with passthrough content to provide desirable experiences. In some implementations, brightness characteristics of a virtual environment (e.g., a scene of a beach, desert, office space, etc.) are precalculated so that adjustments to added content (e.g., UI menus, etc.) can be made more quickly and/or efficiently during live use/blending.

FIG. 7 illustrates presenting views of an XR environment to change a viewing state. In this example, the user 102 wears device 105 while the device 105 displays a first view 705 of an XR environment including a depiction 220 of desk 120. The device 105 provides the first view 705 by displaying passthrough video on the display, for example, based on images of a physical environment 100 around the user 102. In this example, the first view 705 is based on physical environment 100 and, in this example, is a relatively bright view. Presentation of the first view 705 is associated with a viewing state.

At block 702, a method determines a viewing state based on a first brightness characteristic of a first view. In the illustrated example, based on determining that the first view 705 is a bright view (e.g., having an average brightness above a threshold), a bright adapted eye state is determined as the viewing state. At block 704, the method determines an intended viewing state for virtual content, e.g., virtual content to be included in subsequent views of the XR environment. For example, this may involve determining that the virtual content 710 is a movie scene intended for a dark-adapted eye state. At block 706, the method presents a second view to change the viewing state. For example, to change the bright adapted eye state to a dark-adapted eye state, the second view 720 may have reduced brightness (e.g., reduced average brightness or range). At block 708, the method presents a third view with the virtual content. The method may wait for the viewing state to adjust (e.g., waiting a predetermined amount of time or until the user exhibits a dark-adapted or partially-dark adapted eye state). The third view 730 includes the virtual content 710 presented with the still reduced brightness passthrough video, e.g., providing the movie scene and passthrough video in a way that the user experiences it in the intended dark-adapted eye state.

Some implementations disclosed herein intelligently utilize an available range of display brightness. This may involve creating “headroom” by displaying some content, e.g., passthrough video, using less than all of the range so that some of the range (e.g., a “headroom” portion) is reserved for other content. Such display space partitioning may be based on context. For example, the display space may be partitioned one way (e.g., reserving headroom) in one context and in another way (e.g., not reserving headroom) in another context. The display space partitioning may depend upon mode, e.g., media first mode, reality first mode, creation first mode, productivity mode, etc. A productivity mode could be a mode that utilizes dimming or tinting to dim or tint the passthrough, change white-point to provide an appealing work environment, etc., or otherwise try to create a productively supportive environment.

The display space partitioning may depend upon the physical environment, e.g., based on whether the user is inside or outside, in a work environment or a home environment, in a crowded environment or a solo environment, etc.

Some types of content may be intended or otherwise benefit from the use of display space headroom. HDR content or content intended to have distinguishing highlights may be displayed using headroom to provide intended or desirable appearance attributes. Similarly, media such as movies can include graphical features and effects (e.g., lightening, laser bolts, stars, headlights, etc.) that can be displayed using headroom to provide desirable or intended appearances.

Some devices (e.g., some HMDs) may have displays that are not as bright or large as other modern devices (e.g., HDR televisions). Devices with brightness constrained displays (e.g., limited to SDR brightness ranges) can mimic HDR or display HDR content in ways that are closer to their intended appearances using display-space partitioning. Moreover, because HMD (and similar devices) produce substantially all of the light received by a user's eye, these devices are uniquely suited to account for viewing state (e.g., user adaptation to light or dark conditions) in providing user experiences. Such a device may be able to adjust the brightness of the displayed content to adjust the user's perceptual state.

Over time, views can be displayed to intentionally control the viewing state. For example, a device may intentionally reduce the amount of light (e.g., brightness) that a user's eye is receiving and then display brighter content that will be perceived in an intended way. For example, a display may initially use 50 nits of display's 100 nits of brightness capabilities (adapting the user's perceptual state downward) to display SDR content and then use the full 100 nits to mimic display of HDR content. HDR content can be mapped into the extra 50 nits of brightness. A display capable of only displaying SDR content can be used to display HDR content in a way that the user's brain perceives it similar to viewing HDR content on an HDR display. A user may have a fully enjoyable HDR experience even though they're using a device that is not capable of HDR levels of light output.

Some implementations disclosed herein effectively control display brightness to optimize a viewing state. This may involve adjusting display parameters to help prepare a user to better perceive upcoming content. In some implementations, on the basis of the needs of what the user is doing, what kind of content is to be displayed, or what kind of experience they are trying to experience, the device may adjust display parameters to help users adapt down or up as needed in order to create an optimal perceptual experience for subsequently displayed content.

Some implementations disclosed herein adjust the brightness of content provided in XR environment views to avoid undesirable conditions. For example, passthrough video of a brightly lit room with white walls (whiteboards on the walls) may provide an undesirable background for virtual content positioned in front of it. The brightly lit walls/whiteboards may cause the virtual content to appear washed out, e.g., virtual text may be difficult to perceive or read on top of a bright white background passthrough. Some implementations adjust the passthrough, e.g., reducing brightness, and display the virtual content (e.g., user interface content) at increased/full brightness. Virtual content such as user interface content may be presented in a way that it appears to be slightly brighter than the background. Such adjustments may account for the viewing state (e.g., the user's perceptual state). For example, how much brighter to display UI content may depend on the current adaptation state of the user.

Brightness control may be utilized in different ways in different modes. One such mode is a creation first mode (discussed above). In such a mode, for example, two people may need to collaborate to create content, e.g., making editorial decisions on color or contrast. Some implementations map the brightness of the different views provided to the two users to ensure that the user's see the content in the same way. In a creation first mode, the devices may communicate with each other to adjust brightness so that the users experience the content in a common brightness context. It may also control passthrough brightness so that the viewing states of the users are the same, e.g., the users are guided into a common eye adaptation/perceptual state to further ensure that the content is perceived in the same way. Adjustments that are made may be based on technical requirements of content that is being created. So, in addition to making the environments similar, particular content may have requirements, e.g., to be viewed with a particular white point or at a particular brightness level or at a particular relationship to the background in terms of contrast, that can be accounted for in adjusting the display characteristics.

Viewing state may be controlled by adjusting the brightness of the views provided to one or more users. In addition, field of vision can be controlled for example to ensure that virtual content occupies at least a minimum amount of a field of view. This may involve, for example, adjusting the size of virtual content or particular virtual content items relative to the physical environment content. Doing so in the context of multi-user collaboration can further ensure an intended experience, e.g., further ensuring that the user's have similar viewing states and/or experience content similarly, e.g., experiencing tonality and color similarly.

In a media first mode (discussed above), various techniques may be used to achieve a requirement of the media. A media first mode may assign priority to requirements of the media that may have technical requirements that the device will reproduce if within the capabilities of the display or influence the user's perceptual state so that the technical requirements for accurate reproduction of the media are mimicked. An example is video that is supposed to be 1000 nits bright and the device may not be capable of that level of brightness and thus may push the user's adaptation down by dimming everything down to open up the ability to create the highlights in such a way that the user will perceive it in a way similar to the desired way even though the amount of light from the display does not reach the 1000 nits. Some types of media may be reproduced within the limits of the display. For example, cinematic content may be mastered at 48 nits (within the capability of the device) and the device may control rendering of other content to avoid breaking the media first rendering to ensure the other content (e.g., bright UI content) does not appear too bright relative to the media.

Some implementations, adjust the brightness (and/or other display characteristics) of certain pieces/portions of a view, e.g., rendering passthrough, different portions of passthrough, all virtual elements, different virtual elements, together or individually to provide specific viewing modes or achieve certain objectives. In one example, passthrough is adjusted independently of media. In another example, media is adjusted independently of a user interface. If a user is viewing a view that include a dim passthrough environment (e.g., in a dark room), the device may determine to avoid popping up very bright virtual elements (e.g., media or UI) to avoid shocking the user or otherwise providing content in a way that is objectionable or undesirable given the viewing state, e.g., the user's current dim adapted state.

In one example, a user interface is designed or intended for a base view state (e.g., an idealized viewing state) and/or relationship with respect to the rest of a view. Thus, an UI may be displayed relatively brighter when viewed in a dim passthrough environment than when viewed in a brighter passthrough environment. In some implementations, UI content designed to be similar to a surrounding environment but not so similar that it blends in completely with the environment, e.g., so that it appears natural but is not so similar that it is overlooked. A desired level of brightness difference (e.g., a difference that within a range from A to B, where A is greater than zero) may be maintained in presenting a view of a UI with background (e.g., virtual or passthrough) environment. Doing so may aid cognition or recognition of UI content.

Achieving a requirement of media may involve adjusting brightness to utilize headroom and/or change a viewing state. This may involve bringing down the level of the display brightness in order to open up headroom for the display of HDR content. HDR content may be tone-mapped into the reserved headroom portion of the display's brightness range.

Some implementations utilize display brightness to help prepare a user's perceptual state to better advantage what the user is trying to achieve and/or the intention of the user experience. The system may assess what is being displayed and/or user physiological data (e.g., iris size, dilation, etc.) to understand what the user's adapted perceptual state is so that it can optimize the view and content for that particular state. For example, based on understanding that the user has a particular adapted state (e.g., dark adapted), the system may determine to playback a movie in a particular way. In another example, the system may alter the viewing state (e.g., by controlling the brightness of the current view) in anticipation of the needs of an upcoming view. If an upcoming scene in a movie is intended for a dark-adapted state, the brightness leading up to that scene may be intentionally reduced to ensure a dark-adapted state when the scene is played.

Some implementations determine viewing state based on a mapping between viewing state levels and display brightness levels. Some implementations utilize a response time and/or average brightness values over time, e.g., using the average brightness over the last 10, 20, 30, 60, 120, 240, etc. frames to predict a viewing state. A function, e.g., a transfer function between viewing state and lux levels may be used. A machine learning model may be used, e.g., inputting frames, brightness characteristics, and/or user data (e.g., gaze direction, physiological sensor data, etc.) to predict viewing state.

Some implementations provide experiences that are responsive to a measure of brightness that is actually being viewed (e.g., passthrough, virtual, a combination, etc.) rather than the brightness of the actual physical environment, which may differ. Some implementations ensure consistency between passthrough content and virtual content being viewed together. This may involve bringing content values (e.g., SDR values) in line with the passthrough values (SDR values) so that average brightness of the content is similar to the average brightness of the passthrough.

Implementations disclosed herein may also address display imperfections. For example, a display may have an elevated black level that affects the user's perception of what black would look like. Some implementations control brightness to change a viewing state (e.g., adapting the user's perceptual state up or down) to account for the elevated black level. The user's perception of the relationship between standard dynamic range black and standard dynamic range white can be moved up and therefor the slightly elevated black level of the display may seem more black, as intended.

Some implementations change viewing state to account for the device's camera system, e.g., to better align the viewing state (e.g., the adaptive state of the user) with that of the camera system, so that there is more of a one-to-one relationship to provide a higher fidelity experience. Changing viewing state to account for the device's camera system may be particularly useful when the device is being used to photograph or record the physical environment using the camera system, e.g., matching camera conditions with viewing conditions. The system may control the user's perception to move them into perceptual regimes that optimize the display and camera systems built into the device to improve the experience.

In a normal operation mode, the display may be dimmed down to optimize battery power, e.g., to 50% display peak brightness. The user's vision may be expected to naturally adapt down to correctly perceive this lower-brightness level as normal. When the user provides input to take a photo or video using the device, the device may automatically switch into a “Camera First mode.” Such a mode may, for example, change ISP settings to maximize the ability to capture a scene using the full range of pixel coding values. As part of the Camera First mode, the display could gradually brighten up to match the full range of coding values coming from the Camera/ISP. This may provide a more accurate view for the user (as it is in a 1:1 brightness correspondence with the camera's processing) allowing them to better compose shots.

Some implementations present views of XR environments that include multiple virtual content elements, e.g., different apps. Some implementations, adjust brightness based on determining what apps are running and/or how much of a given view or environment each of the apps occupies. Some implementations, adjust brightness based on which of the multiple apps a user is looking at and/or interacting with. Some implementations adjust brightness based on how much of a view is occupied by passthrough video versus virtual content. Some implementations adjust brightness based on how much of a view is associated with a first context or mode versus a second context or mode. Some implementations account for what is within the user's field of view.

Some implementations adjust brightness based on the locations of light sources within a physical environment. Some implementations adjust brightness based on the position of the user's eye within an eye box of an HMD.

Some implementations determine a viewing state based on sensing information about what the user is viewing based on assessing captured passthrough video. The sensing component may not be a physical sensor but instead may be a means of assessing passthrough, e.g., downstream of the camera. Some implementations adjust brightness based on both physical environment brightness (e.g., sensed via an ambient light sensor) and the brightness characteristics of the view the user is viewing on the device's display.

In some implementations, brightness adjustments to XR content are performed on combined content, e.g., on passthrough combined with virtual content. The brightness adjustments may be performed pre-blend or post-blend. Pre-blend may involve subsystems that are creating content elements (e.g., passthrough, media, UI). One of the elements (e.g., passthrough) has adjustments applied to it (e.g., passthrough may have tone-mapping and other adjustments applied via a camera system, ISP, or otherwise). In pre-blend, the other elements (e.g., media, UI) are adjusted based on the adjustments made to the adjusted element so that the other elements can be adjusted accordingly. In a reality first modality, for example, the camera passthrough is adjusted based on information captured by the camera (e.g., the camera is being used as a sensor), the adjustments made to the passthrough are vended out to downstream parts of the system so they can adjust their elements (e.g., media, UI), which apply those to their rending so that when everything is combined together it all looks like it belongs.

In contrast, in a post-blend mode, brightness adjustments (and/or tone-mapping) in which every element does rendering into an idealized/common space where everything is rendered together. The system may have a common characteristic that all systems target in their rendering, e.g., the camera system and the media playback system target that characteristic. Once everything is put together targeting that characteristic, there are operations (e.g., tone-mapping, white-pointing, etc.) and other adjustments that adjust that common characteristic scene. Such adjustments may, for example, make the scene match the characteristics of the display or any of the other adjustments described herein.

There may be advantages and disadvantages to pre-blend and post-blend techniques. The post-blend may give a more seamlessly integrated scene since everything is aligned with respect to a characteristic before being adjusted but there may be some loss of quality. Pre-blend may provide higher individual element quality but less seamlessly integrate the scene.

Some implementations provide a device that is able to seamlessly switch between pre-blend and post-blend brightness adjustments for different purposes and contexts. For example, a system may selectivity use post-blend (e.g., for a reality first mode) and pre-blend (e.g., for a media first mode).

Some implementations are adaptive to low light brightness. The brightness of an environment (e.g., the actual physical environment, the passthrough environment, an all-virtual environment, or a combined real/virtual environment) may be sensed or determined. The brightness of such an environment (or the user's current view of such an environment), may be determined to satisfy a low-brightness criterion, e.g., having a brightness characteristic (e.g., average brightness) that his less than a threshold. Based on determining that the brightness satisfies such a criterion (e.g., that a low light brightness condition exists), a device or method may make one or more adjustments. In one example, based on determining the existence of a low light brightness condition, the brightness (e.g., the SDR brightness) is turned down to reduce eye strain, reduce ghosting, or otherwise improve the user experience.

Some implementations determine that a view that includes passthrough content (e.g., an all passthrough view or a blended view) is of a dark environment, e.g., the environment or view having a brightness characteristic that satisfies a criterion. Based on determining this condition, the system may reduce the SDR brightness down to an ISP level. As long as the scene that the user is looking at is below the SDR level, a linear tone mapping may be used. As the brightness is reduced, the user's eye may naturally compensate such that the user does not actually see any brightness change, e.g., in the passthrough. A similar approach may be used for virtual environments to compensate for dark environments, e.g., as the brightness is turned down, the environment brightness is adjusted accordingly.

FIG. 8 is a flowchart illustrating an exemplary method 800 for presenting views of an XR environment based on a viewing state. In some implementations, the method 800 is performed by a device, such as a mobile device (e.g., device 110 of FIG. 1A), desktop, laptop, HMD, or server device. In some implementations, the device has a screen for displaying images and/or a screen for viewing stereoscopic images such as an HMD e.g., device 105 of FIG. 1B. In some implementations, the method 800 is performed by processing logic, including hardware, firmware, software, or a combination thereof. In some implementations, the method 800 is performed by a processor executing code stored in a non-transitory computer-readable medium (e.g., a memory). Each of the blocks in the method 800 may be enabled and executed in any order.

At block 802, the method 800 presents a first view (e.g., one or more frames) of an XR environment on a display while an HMD is worn by a user. The display may produce substantially all of the light that is visible to an eye of the user. The first view may be all virtual, all real/passthrough video (e.g., before a UI window is opened), or a combination of virtual and real/passthrough video. The first brightness characteristic may be an average brightness level of the first view. The first brightness characteristic may provide a histogram of brightness values (e.g., identifying how many pixels have brightness values in certain ranges). The first brightness characteristic may provide a range of brightness.

In some implementations, the XR environment includes a passthrough view of a physical environment from a viewpoint position within the physical environment. An average brightness of the first view of the XR environment will generally be different than an average brightness of a view of the physical environment from the viewpoint position, for example, in circumstances in which display brightness limitations or parameters limit the display of high luminance content relative to the actual luminance of a sunlit or otherwise brightly lit room. The first view of the XR environment may include depictions of a physical environment and depictions of a virtual content.

The first view may include (or be based upon) a passthrough video signal from an image sensor such as a camera. In some implementations, the passthrough video signal includes passthrough video depicting a physical environment. In some implementations, the passthrough video may be associated with an image signal processing (ISP) tone map (e.g., curve) relating pixel luminance values of the passthrough video signal to display space luminance values. In some implementations, the ISP tone map is periodically updated with respect to ISP tone map modifications occurring while a user is viewing bright or dark portions of the environment. In some implementations, periodically updating the ISP tone map occurs during every frame of the passthrough video.

At block 804, the method 800 determines a viewing state (e.g., an eye adaptation state of the eye) based at least in part on a first brightness characteristic of the first view. The viewing state may be an eye perception state of the user determined, for example, based on an average brightness level of the first view. The viewing state may be determined based on the video frame characteristics and the device's display's specification (e.g., using manufacturing information and tolerances). The viewing state (e.g., eye adaptation/perception state) might be determined or confirmed using an inward eye camera to assess pupil dilation or other physiological characteristics of the user.

At block 806, the method 800 determines a second brightness characteristic (e.g., remapping to new range or shifting to achieve a new average brightness) for at least a portion (e.g., passthrough portion, virtual portion, or both) of a second view of the XR environment based on the viewing state. In one example, the first view is presented using a first range of brightness values and determining the second brightness characteristic comprises selecting a second range of brightness values different than the first range for presenting the second view.

The method 800 may identify virtual content for inclusion in the second view and determine the second brightness characteristic by selecting a range of brightness values for the virtual content based on the viewing state. The method 800 may identify virtual content for inclusion in the second view and determine the second brightness characteristic based on the first brightness characteristic of the first view, e.g., to adjust the virtual content and/or passthrough content.

The method 800 may identify virtual content for inclusion in the second view determine the second brightness characteristic by selecting a range of brightness values or an average brightness for the virtual content based on a brightness range or an average brightness of the first view.

The second brightness characteristic may be determined based on a brightness requirement. The brightness requirement may be based on a requirement for the second view. Such a requirement may be determined based on an intended viewing state for content to be included in the second view of the XR environment (e.g., a content specification provided in content metadata, based on content types, etc.). Such a requirement may be determined based on a virtual content priority (e.g., media first). Such a requirement may be determined based on a reality priority (e.g., reality first). Such a requirement may be determined based on a collaboration/creation priority. (e.g., creation first).

At block 808, the method 800 presents the second view of the XR environment. The method 800 may adjust virtual content to be added to passthrough video to provide the second view. Virtual content may be adjusted based on the second brightness characteristic, the passthrough video may be adjusted based on the adjusting of the virtual content, and then the virtual content and passthrough combined (e.g., a pre-blend adjustment process). The virtual content may be adjusted based on the second brightness characteristic after combination with the passthrough video utilizing a common compositional space (e.g., a post-blend adjustment process).

Some implementations disclosed herein provide immersive environment themes (e.g., fall, spring, summer, winter) using color tinting, e.g., tinting some or all portions of passthrough video. The tinting may provide the content with an intended white point, e.g., a cool bluish color for winter or a warm color for fall.

FIG. 9 is a flowchart illustrating an exemplary method 900 for presenting views of an XR environment based on a viewing theme. In some implementations, the method 900 is performed by a device, such as a mobile device (e.g., device 110 of FIG. 1A), desktop, laptop, HMD, or server device. In some implementations, the device has a screen for displaying images and/or a screen for viewing stereoscopic images such as an HMD, e.g., device 105 of FIG. 1B. In some implementations, the method 900 is performed by processing logic, including hardware, firmware, software, or a combination thereof. In some implementations, the method 900 is performed by a processor executing code stored in a non-transitory computer-readable medium (e.g., a memory). Each of the blocks in the method 900 may be enabled and executed in any order.

At block 902, the method determines a viewing theme for a XR environment to be viewed on a display while an HMD is worn by a user. For example, a target color scheme may be defined by virtual content to be displayed in the XR environment, e.g., in an app executing with in the XR environment and configured to display content. At block 904, the method 900 obtains image data depicting a physical environment and, at block 906, maps the image data based on a predetermined white point. This may involve dynamic color tone-mapping, for example, by a camera ISP to map camera image to predefined neutral white point. At block 908, the method 900 applies a color effect to the image data based on the viewing theme. For example, this may involve applying an additive color tint in dedicated camera-to-display path to apply the color. At block 910, the method 900 presents a view of the XR environment based on the image data.

In some implementations, the HMD operates in both a first mode in which color effects are applied based on viewing themes and a second mode in which tone-mapping is performed to match color characteristics of the view with color characteristics of the physical environment. In a default mode, camera tone-mapping may be performed to best match the physical environment, e.g., color feels as if the user were not looking through the device.

In some implementations, the method 900 determines to apply the color effect based on determining to display a virtual content item in the XR environment. In some implementations, the method 900 determines to apply a light spill effect proximate the virtual content item based on determining to display the virtual content item in the XR environment.

FIG. 10 is a block diagram of an example device 1000. Device 1000 illustrates an exemplary device configuration for electronic devices 105 and 110 of FIGS. 1A and 1B. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICs, FPGAs, GPUs, CPUs, processing cores, and/or the like), one or more input/output (I/O) devices and sensors 1004, one or more communication interfaces 1008 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 1010, output devices (e.g., one or more displays) 1012, one or more interior and/or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 1012 are configured to present a view of a physical environment, a graphical environment, an extended reality environment, etc. to the user. In some implementations, the one or more displays 1012 are configured to present content (determined based on a determined user/object location of the user within the physical environment) to the user. In some implementations, the one or more displays 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 1012 correspond to diffractive, reflective, polarized, holographic, etc. waveguide displays. In one example, the device 1000 includes a single display. In another example, the device 1000 includes a display for each eye of the user.

In some implementations, the one or more image sensor systems 1014 are configured to obtain image data that corresponds to at least a portion of the physical environment 100. For example, the one or more image sensor systems 1014 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 1000 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 1000 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 1000.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 includes a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of electrical charge. In some implementations, the instruction set(s) 1040 are software that is executable by the one or more processing units 1002 to carry out one or more of the techniques described herein.

The instruction set(s) 1040 include a brightness adjustment instruction set 1042 and a tint adjustment instruction set 1044 performing brightness and tint adjustment functions as described herein. The instruction set(s) 1040 may be embodied as a single software executable or multiple software executables.

Although the instruction set(s) 1040 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a head-mounted device (HMD) having a processor and a display:
presenting a first view of an extended reality (XR) environment on the display while the HMD is worn by a user;
determining a viewing state based at least in part on a first brightness characteristic of the first view;
determining a second brightness characteristic for at least a portion of a second view of the XR environment based on the viewing state; and
presenting the second view of the XR environment.

2. The method of claim 1, wherein the first brightness characteristic is an average brightness level of the first view.

3. The method of claim 1, wherein:
the first view is presented using a first range of brightness values; and
determining the second brightness characteristic comprises selecting a second range of brightness values different than the first range for presenting the second view.

4. The method of claim 1, wherein the viewing state comprises an eye perception state of the user determined based on an average brightness level of the first view.

5. The method of claim 1, wherein the viewing state comprises an eye perception state of the user determined based on determining a pupil dilation of the user.

6. The method of claim 1 further comprising identifying virtual content for inclusion in the second view,
wherein determining the second brightness characteristic comprises selecting a range of brightness values for the virtual content based on the viewing state.

7. The method of claim 1 further comprising identifying virtual content for inclusion in the second view,
wherein the second brightness characteristic is based on the first brightness characteristic of the first view.

8. The method of claim 1 further comprising identifying virtual content for inclusion in the second view,
wherein the second brightness characteristic comprises selecting a range of brightness values or an average brightness for the virtual content based on a brightness range or an average brightness of the first view.

9. The method of claim 1, wherein the second brightness characteristic is based on a requirement for the second view.

10. The method of claim 9, wherein the requirement is determined based on an intended viewing state for content to be included in the second view of the XR environment.

11. The method of claim 9, wherein the requirement is determined based on:
a virtual content priority;
a reality priority; or
a collaboration priority.

12. The method of claim 1 further comprising adjusting virtual content to be added to passthrough video to provide the second view, wherein the virtual content is adjusted based on the second brightness characteristic during a tone-mapping process prior to being combined with the passthrough video.

13. The method of claim 1 further comprising adjusting virtual content to be added to passthrough video to provide the second view, wherein the virtual content is adjusted based on the second brightness characteristic during a tone-mapping process after combination with the passthrough video such that the passthrough video and virtual content utilize a common compositional space.

14. The method of claim 1, wherein the XR environment comprises a passthrough view of a physical environment from a viewpoint position within the physical environment, wherein an average brightness of the first view of the XR environment is different than an average brightness of a view of the physical environment from the viewpoint position.

15. The method of claim 1, wherein first view of the XR environment comprises depictions of a physical environment and depictions of a virtual content.

16. A head-mounted-device (HMD) comprising:
a non-transitory computer-readable storage medium;
a display; and
one or more processors coupled to the non-transitory computer-readable storage medium, wherein the non-transitory computer-readable storage medium comprises program instructions that, when executed on the one or more processors, cause the electronic device to perform operations comprising:
presenting a first view of an extended reality (XR) environment on the display while the HMD is worn by a user, wherein the display produces substantially all of the light that is visible to an eye of the user;
determining a viewing state based at least in part on a first brightness characteristic of the first view;
determining a second brightness characteristic for at least a portion of a second view of the XR environment based on the viewing state; and
presenting the second view of the XR environment.

17. The HMD of claim 16, wherein the viewing state comprises an eye perception state of the user determined based on an average brightness level of the first view.

18. The HMD of claim 16, wherein the operations further comprise identifying virtual content for inclusion in the second view,
wherein determining the second brightness characteristic comprises selecting a range of brightness values for the virtual content.

19. The HMD of claim 16, wherein the operations further comprise identifying virtual content for inclusion in the second view,
wherein the second brightness characteristic comprises selecting a range of brightness values or an average brightness for the virtual content based on a brightness range or an average brightness of the first view.

20. A non-transitory computer-readable storage medium storing program instructions executable via one or more processors, of a head-mounted-device having a display, to perform operations comprising:
presenting a first view of an extended reality (XR) environment on the display while the HMD is worn by a user, wherein the display produces substantially all of the light that is visible to an eye of the user;
determining a viewing state based at least in part on a first brightness characteristic of the first view;
determining a second brightness characteristic for at least a portion of a second view of the XR environment based on the viewing state; and
presenting the second view of the XR environment.
